(19) United States
(12) Patent Application Publication
(10) Pub. No.: US 2018/0217331 A1
(43) Pub. Date: Aug. 2, 2018

(54) A SLOW-LIGHT GENERATING OPTICAL DEVICE AND A METHOD OF PRODUCING SLOW LIGHT WITH LOW LOSSES

(71) Applicant: UNIVERSITY OF COPENHAGEN, Copenhagen K (DK)

(72) Inventors: Søren STOBBE, Copenhagen V (DK); Sahand MAHMOODIAN, Copenhagen (DK); Peter LODAHL, Birkerød (DK); Pedro David Garcia FERNANDEZ, Copenhagen N (DK)

(73) Assignee: UNIVERSITY OF COPENHAGEN, Copenhagen K (DK)

(21) Appl. No.: 15/568,096

(22) PCT Filed: Apr. 19, 2016
(86) PCT No.: PCT/EP2016/058661

§ 371 Date: Oct. 20, 2017

(30) Foreign Application Priority Data
Apr. 20, 2015 (EP) 15164242.8

(51) Int. Cl. G02B 6/122; G02B 6/126

(52) U.S. Cl. CPC G02B 6/1225; G02B 2006/1213; G02F 2202/32; G02B 6/126

(57) ABSTRACT

A slow-light generating optical device (1) is disclosed. The optical device comprises a planar waveguide (2), and the planar waveguide comprises: a longitudinal extending guiding region (4) with a first side (6) and a second side (8), a first nanostructure (7) arranged on the first side (6) of the guiding region (4), and a second nanostructure (9) arranged on the second side (7) of the guiding region (4). The planar waveguide (2) includes a first longitudinal region where the first nanostructure (7) and the second structure (9) are arranged substantially glide-plane symmetric about the guiding region (4) of the planar waveguide, and the first and the second nanostructures (7, 9) are designed so that the planar waveguide has a band structure and is adapted to guide a forward propagating mode and a backward propagating mode possessing energy bands, which individually are non-degenerate and mutually degenerate, and which intersect each other and form a Dirac point at a Brillouin zone edge.

### FIELD OF THE INVENTION

The present invention relates to a slow-light generating optical device and a method of producing slow light.

### BACKGROUND OF THE INVENTION

Light travels at 299,792,458 metres per second. This huge speed makes it perfect for telecommunication across different continents. For such applications, it is also fortunate that light interacts only very weakly with the medium within which it travels, and therefore light pulses can travel very long distances in optical fibres before being absorbed or degraded. This weak interaction with matter does, however, have its downside; it makes it very difficult to manipulate the properties of a light pulse in such a medium. Ideally, one would like to be able to propagate light very long distances in a weakly interacting medium and then, when manipulation and control of light are required, propagate in a strongly interacting medium. One strategy for achieving such a strongly interacting medium is to engineer a photonic material where light propagation slows down. This is referred to as slow light.

There has been a recent boom in using optical interconnects to send information from one electronic processing unit to another. This is due to the limited bandwidth of electrical interconnects as well as a reduction in energy consumption in transmitting light. In general, optical components are being further and further integrated into CMOS integrated circuits. One optical component that has been elusive is an on-chip optical buffer—a component that can delay an optical pulse for a short time and then release it. This is because the nanophotonic circuits that have been used thus far have considerable scattering losses and have only demonstrated modest delays (500 picoseconds with 7 dB of loss).

Photonic-crystal waveguides have been researched extensively in recent years due to their ability to control and slow-down the speed of light propagation. In theory, photonic-crystal waveguides can reduce the speed at which a light pulse propagates, known as its group velocity, to zero. Unfortunately, this cannot be realized experimentally as nanometre-scale imperfections inevitably introduced during the fabrication process disturb light propagation causing light to scatter back in the opposite direction or out of the waveguide. Somewhat ironically, this disorder-induced scattering is exacerbated by slow light as the slowdown leads to light interacting more strongly with the disorder in the waveguide. In fact, when the slow-down factor reaches a value of around 40, the backscattering is so strong that light is localized in less than 10 micrometres due to so-called Anderson localization. This has so far prevented any commercial application of photonic-crystal waveguides for slow-light devices.

“Space group theory and Fourier space analysis of two-dimensional photonic crystal waveguides”, Adam Mock et al., Physical Review B, 155115 (2010) discloses a so-called type B photonic-crystal waveguides, where the photonic-crystal lattice on each side of the guiding region is shifted in the longitudinal direction by half a period, thereby possessing glide-plane symmetry. The type B waveguides are utilised to reduce the out-of-plane radiation losses from linear polarised light propagating through photonic-crystal waveguides. However, the article does not relate to the formation of slow light, and the described waveguides are prone to large backscattering losses due to manufacturing imperfections as explained in the aforementioned paragraph.

### SUMMARY OF THE INVENTION

It is an object of the invention to obtain a slow-light generating optical device and a method of producing slow light, which overcome or ameliorate at least one of the disadvantages of the prior art or which provides a useful alternative.

According to a first aspect, the invention provides a slow-light generating optical device, wherein the optical device comprises a planar waveguide, wherein the planar waveguide comprises:
a longitudinal extending guiding region with a first side and a second side,
a first nanostructure arranged on the first side of the guiding region, and
a second nanostructure arranged on the second side of the guiding region, wherein
the planar waveguide includes a first longitudinal region, where the first nanostructure and the second structure are arranged substantially glide-plane symmetric about the guiding region of the planar waveguide, and wherein
the first and the second nanostructures are designed so that the planar waveguide has a band structure and is adapted to guide a forward propagating mode and a backward propagating mode possessing energy bands, which individually are non-degenerate and mutually degenerate, and which intersect each other and form a Dirac point at a Brillouin zone edge.

By designing the nanostructures so that the forward propagating mode and the backward propagating mode are individually non-degenerate but mutually degenerate, it is ensured that unavoidable isotropic perturbations introduced during fabrication do not couple the forward and the backward propagating modes, which in turn ensures low or no backscattering and hence low losses. Accordingly, it is possible to manufacture very long delay lines and produce large delays without significant loss and in particular without Anderson localization. It is recognised that the nanostructures of the planar waveguide needs to be modified compared to conventional waveguides in order to exhibit the necessary characteristics for generated slow light. Accordingly, the nanostructures may also be perceived as being arranged in a modified glide-plane symmetric design.

The device has the potential to reduce the loss in a delay line and thus allow it to be extended to provide a significantly larger delay. Current designs have group velocities as low as c/100 and negligible losses have been obtained for planar waveguides of 300 micrometres.

In general, the first nanostructure and the second nanostructure need to be arranged with some sort of periodicity and the periodicity of the first nanostructure and the second nanostructure are mutually shifted or translated in the longitudinal direction of the planar waveguide and thus that the mirror symmetry is broken. By “substantially glide-plane symmetric” is meant that the two nanostructures are mutually shifted by approximately half a period.

The nanostructures are advantageously arranged in a lattice structure, i.e. the first nanostructure arranged in a first lattice structure, and the second nanostructure arranged in a second lattice structure. Since the nanostructures are arranged substantially with glide-plane symmetry, this means that the first lattice structure and the second lattice structure are mutually shifted with substantially half a period or lattice constant in the longitudinal direction of the waveguide.

It should be noted that the term “longitudinal” does not mean that the guiding region is necessarily arranged along a straight line. It means that the light in general propagates in a given direction of the waveguide.

It is also noted that the term “nanostructure” should also not be perceived in a too limiting manner. It merely indicates that the nanostructure has a relative small dimensions e.g. in the size from tens of nanometres to thousands of nanometres. The holes are typically defined in terms of the period, which is related to the wavelength of operation. The period of the lattice is approximately equal to the wavelength divided by the refractive index of the material (3.46 for Gallium Arsenide). The radius of the holes can vary but typically lie between 0.25a-0.35a, where a is the period. A nanostructure comprises a plurality of holes, which is arranged in a background material, where the material of the holes and the material of the background material have different refractive indices. The holes may be air holes or holes made from a different material than the background material. Accordingly, the first nanostructure may comprise first holes on a first side of the guiding region, and the second nanostructure may comprise second holes on a second side of the guiding region.

Further, the term “optical” should also not be perceived in a too limiting manner, and it is recognised that the optical range comprises infrared light, visible light and ultraviolet light. Further, it is also conceived that the invention is applicable for microwaves, x-rays and the like, in particular for a detector setup. Accordingly, the term may also encompass such frequencies and wavelengths, although the preferred wavelength range comprises the range from infrared light to ultraviolet light. The nanostructures should of course be designed according to the given frequency and wavelength range.

The Brillouin zone edge is defined as follows. A periodic structure consists of a primitive unit cell, which is replicated in space. This periodicity in space also implies that there is a periodicity in reciprocal space or momentum space. The unit cell in reciprocal space is called the Brillouin zone. The Brillouin zone edge is the edge of this unit cell in momentum space. In a one dimensionally periodic structure the Brillouin zone edge is simply a point. Only the first Brillouin zone is relevant. The first Brillouin zone extends from the lower Brillouin zone edge at −a/(2*pi) to the upper Brillouin zone edge at a/(2*pi).

The Dirac Point is defined as follows. A Dirac point is a crossing between two bands, where the slopes of the two bands are linear. There should be no other bands existing at the energy, which the Dirac point occurs.

The energy bands of the forward and backward propagating modes may advantageously be substantially mirror-symmetric about the Dirac point.

In an alternative wording of the first aspect, the invention provides a slow-light generating optical device, wherein the optical device comprises a planar waveguide, wherein the planar waveguide comprises:
a longitudinal extending guiding region with a first side and a second side,
a first nanostructure arranged on the first side of the guiding region, and
a second nanostructure arranged on the second side of the guiding region, wherein
the planar waveguide includes a first longitudinal region where the first nanostructure and the second structure are arranged substantially glide-plane symmetric about the guiding region of the planar waveguide, and wherein
the first and the second nanostructures are designed so that the planar waveguide has a band structure and is configured to guide a forward propagating mode and a backward propagating mode possessing energy bands, wherein
the energy band of the forward propagating mode is monotonically increasing as a function of a wave vector within a finite range on both sides of the first Brillouin zone edge and the backward propagating mode is monotonically decreasing as a function of a wave vector within a finite range on both sides of the first Brillouin zone edge, or vice versa.

This ensures that the forward propagating mode and the backward propagating modes are individually non-degenerate. Accordingly, in one embodiment, the energy bands of the forward propagating mode and backward propagating mode individually are non-degenerate and may be mutually degenerate.

The energy bands of the forward propagating mode and the backward propagating mode may cross each other at a crossing-point. The energy bands of the forward propagating mode and the backward propagating mode are substantially symmetric about the crossing point. The energy bands of the forward propagating mode and the backward propagating mode may form a Dirac point. The Dirac point is advantageously formed at a Brillouin zone edge. The Brillouin zone edge is formed at k*a/(2*pi)=0.5, where k is the wavenumber, and a is a lattice constant of the first and second nanostructure.

In the following a number of different embodiments are described that apply both the to the invention described in the first aspect in the original or alternative wording.

According to one embodiment, the forward propagating mode and the backward propagating mode are counter-propagating circular polarized modes. Symmetry requires that the two modes are degenerate at the Brillouin zone edge. This may be achieved when the two modes have different circular polarizations. This implies that if the forward propagating mode is locally right-hand (or clockwise) circularly polarized, the backward propagating mode is left-hand (or counter-clockwise) circularly polarized.

It should be noted that “the circular polarized modes” are not circularly polarized in the conventional sense. In terms of the present invention and planar waveguides, it means that at the spatial positions, where the electric field strength of the mode is substantially largest, the electric field vector is circularly polarized within the plane of the structure. The actual position, where the electrical field vector is perfectly circularly polarized may be slightly away from the maximum but always near the maximum.

In an advantageous embodiment, energy bands of the forward propagating mode and the backward propagating mode are monotonically dependent on the wave vector of light propagating along the waveguide direction. This ensures that the forward propagating mode and the backward propagating modes are individually non-degenerate.

The planar waveguide is preferably a photonic-crystal waveguide.

In an advantageous embodiment, the planar waveguide is designed so that a group velocity v_{g} of a guided forward propagating mode is significantly lower than c/n, where c is the velocity of light and n is the refractive index of the waveguide material. A group velocity of the guided forward propagating mode may for instance be at least a factor 5 lower than the speed of light in vacuum, e.g. at least a factor 10, or 15, or 20, or 25 lower than the speed of light in vacuum.

Overall, it is seen that the planar waveguide is adapted to guide slow modes in the longitudinal direction of planar waveguide. The group velocity may for instance be at least a factor 10 lower than c/n. The group velocity may be as much as a factor 250, or even a factor 500 or factor 1000 lower than the speed of light in vacuum.

Another measure for the slow light is the group index n_{g}. Advantageously, the group index n_{g}=c/v_{g} is at least 5, more advantageously at least 7, and even more advantageously at least 10. Even further, n_{g} may be at least 15, or at least 20, or at least 25. The group index n_{g} may for instance lie in the range 20-200, or 25-150, or 30-120. Accordingly, the planar waveguide may also be denoted high group index (high-n_{g}) section.

It is recognised that the slow light guiding planar waveguides can be designed in a number of ways in order to provide slow group velocity guided modes. This may depend on the thickness of the membrane or wafer, the width of the guiding region as well as the refractive indices of the material that make up the nanostructures (typically varying between the refractive index of the material and 1, due to the use of air holes), and the lattice or period constant of the nanostructures. Thus, it is seen that the key is to provide guided modes with low group velocity, which may be achieved by utilising modes close to the Brillouin zone edge.

In one embodiment, the planar waveguide is made from a dielectric material, such as an III-V semiconductor material or a silicon-based material, e.g. silicon dioxide and/or silicon nitride. The III-V semiconductor material may for instance be made of Gallium Arsenide (GaAs), Indium Gallium Arsenide (InGaAs), or Aluminium Arsenide (AlAs). Other suitable material may be silicon-based materials, e.g. Silicon Nitride, or diamond.

The optical device may advantageously be provided on a single substrate. The substrate can be manufactured in one or a few steps and thus be mass-produced in manufacturing facilities known per se.

Advantageously, the first nanostructure and/or the second nanostructure comprise air holes. However, in principle the nanostructure may also be made of a different material than the remainder of the planar waveguide material and having a refractive index being different from that of the remainder.

In one embodiment, the planar waveguide is made of a material having a refractive index in the region of 2-5, or 2.5-4.5, e.g. around 3.5, i.e. the material is made of e.g. a high refractive index dielectric. In another embodiment, a difference in refractive index of the planar waveguide material and the first and second nanostructures is in the region of 1-4, or 1.5-3.5, e.g. around 2.5.

In yet another embodiment, the planar waveguide is adapted to guide light within a wavelength interval in the region of 620-1200 nm, and wherein the quantum emitter emits photons having a wavelength within said interval.

The first nanostructure and the second nanostructure are arranged in a first lattice structure and a second lattice structure, respectively, advantageously arranged in a triangular lattice and having a lattice constant a, at least in the longitudinal direction of the planar waveguide. However, the interlinear spacing between adjacent rows may be modified in order for the planar waveguide to have the desired band structure. Accordingly, a in general refers to the longitudinal distance between adjacent holes in a row.

In general the design of the nanostructure, e.g. the lattice structure of the photonic crystal waveguide, should be matched to the desired guided modes. The in-waveguide wavelength may for instance be twice the length of the lattice constant.

The planar waveguide may advantageously have a longitudinal extent or length of at least 50 micrometres, more advantageously at least 100 micrometres. The combination of a slow light and a relative long waveguide section allows for significant delays. Experiments have shown that waveguides according to the invention may have an extinction range of at least 300 micrometres, the extinction range being the length over which the intensity of transmitted light is reduced by a factor 1/e. As long as the loss is kept low, the longitudinal extent of the planar waveguide may be arbitrary. It is contemplated that the longitudinal extent may be as much as 1000 micrometres or even more, such as up to 300 mm. The longitudinal extent may be at least 5 lattice constants a, or it may be at least 10, 20, 30, 40, 50, 60, 70, 80, 90, or 100 lattice constants a.

The lattice constant a may for instance lie in the interval 100-500 nm, or 150-400 nm, or 200-300 nm, e.g. around 250 nm.

The width of the guiding region may for instance be in the region 100-1000 nm, or in the region of 0.5 to 2 times the lattice constant a. The guiding region is often formed by removing a row of holes. Accordingly, the transverse distance between centres of proximal nanostructures (e.g. holes) on the first side and the second side is √3 times the lattice constant a. However, in order to modify the waveguide to have the desired band structure according to the invention, it may also be necessary to alter the width of the guiding region compared to conventional waveguides.

In an advantageous embodiment, the planar waveguide has a thickness of between 0.2a and 1.4a, or between 0.25a and 1.0a, or between 0.3a and 0.8a, e.g. around 0.5a or 0.6a. Alternatively, the planar waveguide may have a thickness in the range of 50-500 nm, or 75-350 nm, or 100-250 nm, e.g. around 150 nm. Accordingly, it is seen that the planar waveguide is a slab waveguide. The waveguide may for instance be designed as a membrane, e.g. as a floating structure, but it may also be designed as a ridge-like platform, where the waveguide is arranged on a material with a low refractive index. This may be particular relevant for a silicon-on-insulator design.

The planar waveguide is advantageously designed as a floating structure along at least a substantial part of the planar waveguide. Such a design minimises the losses by minimising light being coupled out of the plane. Alternatively, the waveguide may be arranged on top of a material, said material preferably having a relative low refractive index.

In one embodiment, the first nanostructure and/or the second nanostructure comprise a number of first rows comprising first holes proximal to the guiding region, and a number of second rows comprising second holes juxtaposed to the first rows, wherein the first holes have a first diameter, and the second holes have a second diameter, being different from the first diameter. The second diameter may for instance be smaller than the first diameter, e.g. 50-90% of the first diameter. The first nanostructure and/or the second nanostructure may additionally comprise a number of third rows comprising third holes juxtaposed to the second rows, wherein the third holes have a third diameter, and wherein the third diameter is different from the second diameter. The second diameter is smaller than the third diameter, e.g. 50-90% of the third diameter. The nanostructures may for instance comprise two first rows, one second row, and one third row. The distance between adjacent rows may be slightly modified compared to conventional designs. The relative size of the holes of each row may also be applied to a design having for instance triangular or rectangular holes, the holes then being characterised by their side lengths or a maximum inner dimension.

In another embodiment, the first and/or the second nanostructure comprise indentations, corrugations, undulations or the like formed in lateral sides of the waveguide. The waveguide may be designed so that the nanostructures are formed by indentations, corrugations, undulations or the like only.

Advantageously, the first and the second nanostructures are designed so that the waveguide is configured to only guide the forward propagating mode and the backward propagating mode.

The invention also provides an optical delay device comprising a slow-light generating optical device according to any of the aforementioned embodiments. The invention further provides an optical buffer for a communication device, the optical buffer comprising a slow-light generating optical device according to any of the aforementioned embodiments. The invention additionally provides a delay line comprising a slow-light generating optical device according to any of the aforementioned embodiments. In addition hereto, the invention provides a quantum simulator comprising such a delay line.

It is clear that the waveguide or the slow-light generating devices as described may be used for a vast number of devices. The device may for instance be chosen from the group of on-chip lasers, pulsed lasers, light emitting diodes, spectral filters, beam splitters, single photon sources, single photon detectors, optical amplifiers, arrayed waveguide gratings, dispersion compensators, optical buffers, optical parametric amplifiers, optical parametric oscillators, optical spectrum analysers, diffraction gratings, prisms, optical switches, optical circulators, optical isolators, Faraday rotator, supercontinuum source, mode-locked lasers, and soliton mode-locked lasers.

According to a second aspect, the invention provides a method of producing slow light, wherein the method comprises the step of guiding light into a planar waveguide comprising a longitudinal extending guiding region with a first side and a second side, a first nanostructure arranged on the first side of the guiding region, and a second nanostructure arranged on the second side of the guiding region, where the first nanostructure and the second structure are arranged substantially glide-plane symmetric about the guiding region of the planar waveguide, wherein the first nanostructures are designed so that the planar waveguide is adapted to guide a forward propagating mode and a backward propagating mode possessing band structures, which individually are non-degenerate and mutually degenerate, and which intersect each other and form a Dirac point at a Brillouin zone edge.

The second aspect also provides a method of producing slow light, wherein the method comprises the step of guiding light into a planar waveguide comprising a longitudinal extending guiding region with a first side and a second side, a first nanostructure arranged on the first side of the guiding region, and a second nanostructure arranged on the second side of the guiding region, where the first nanostructure and the second structure are arranged substantially glide-plane symmetric about the guiding region of the planar waveguide, wherein the first and the second nanostructures are designed so that the planar waveguide has a band structure and is configured to guide a forward propagating mode and a backward propagating mode possessing energy bands, wherein the energy band of the forward propagating mode is monotonically increasing as a function of a wave vector within a finite range on both sides of the first Brillouin zone edge and the backward propagating mode is monotonically decreasing as a function of a wave vector within a finite range on both sides of the first Brillouin zone edge, or vice versa.

### BRIEF DESCRIPTION OF THE FIGURES

The invention is explained in detail below with reference to embodiments shown in the drawings, in which

FIG. 1 shows a schematic drawing of a planar waveguide of a slow-light generating optical device according to the invention,

FIG. 2 shows a dispersion curve of a planar waveguide according to the invention,

FIG. 3 shows a schematic drawing of a slow-light generating optical device according to the invention,

FIG. 4 illustrates the guiding region of a compact waveguide of a slow-light generating optical device according to the invention,

FIG. 5 illustrates a waveguide having a waveguide region with a double spiral design,

FIG. 6 shows a first example of a planar waveguide exhibiting the dispersion characteristics according to the invention,

FIG. 7 shows a second example of a planar waveguide exhibiting the dispersion characteristics according to the invention,

FIG. 8 shows a third example of a planar waveguide exhibiting the dispersion characteristics according to the invention,

FIG. 9 shows an alternative embodiment of a planar waveguide with glide plane symmetry.

### DETAILED DESCRIPTION OF THE INVENTION

Planar photonic crystal waveguides are well-known in the art for controlling light propagation, e.g. for slowing down light. The photonic crystal waveguides are typically designed with two nanostructures arranged about a guiding region in an up-down or mirror symmetric design. However, so-called type B W1 photonic crystal waveguides have also been suggested, e.g. in articles by Adam Mock et al., for reducing out-of-plane radiation losses from linear polarised light propagating through the waveguide. However, the shown waveguides are not suitable for slowing down light and hence not suitable for use as an optical buffer or delay circuit, since the described waveguides and band structures are prone to large backscattering losses due to manufacturing imperfections.

The present inventors have found that the type B photonic crystal waveguides may be modified so that the waveguide exhibits a dispersion relation, where backscattering losses due to manufacturing imperfections are virtually eliminated, whereby the waveguides may be provided with a substantial length and hence facilitate a large delay with low or no losses.

Accordingly, the invention provides a slow-light generating optical device 1 comprising a planar waveguide 2. The planar waveguide 2 comprises a longitudinal extending guiding region 4 with a first side 6 and a second side 8. A first nanostructure 7 comprising holes arranged in a modified triangular lattice structure with a longitudinal lattice constant a is located on the first side 6 of the guiding region 4, and a second nanostructure 9 comprising holes arranged in a similarly modified triangular lattice structure with a longitudinal lattice constant a is located on the second side 8 of the guiding region 4. In at least a first longitudinal section of the waveguide, the first nanostructure 7 and the second nanostructure 9 are arranged substantially glide-plane-symmetric about the guiding region 4 of the planar waveguide 2.

The planar waveguide 2 with glide-plane-symmetric nanostructures 7, 9 about a guiding region 4 provides a waveguide, whose modes have electric fields with a strong in-plane circular polarisation. However, compared to prior art type B waveguides, the lattice structure has been modified in order to provide a band structure that ensures low backscattering losses from manufacturing imperfections.

The design of the planar waveguide 2 may in general be defined by used of a number of different characteristics, such as the longitudinal lattice constant a, the width w of the guiding region 4, the distance between rows in the lattice structure and the radius (or other dimensions) of the holes 7, 9, and the shape of the holes.

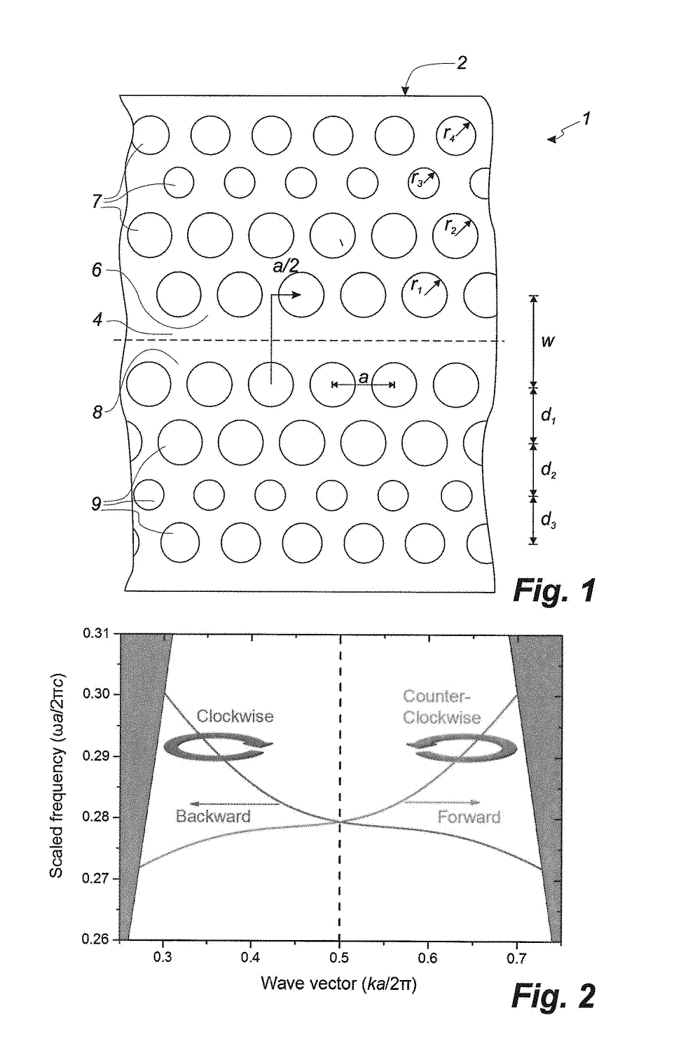

In FIG. 1, the planar waveguides is depicted with a first row of holes proximal to the guiding region, the holes having a radius r₁, a second row adjacent the first row, the holes of the second row having a radius r₂, a third row adjacent the second row, the holes of the third row having a radius r₃, and a fourth row adjacent the third row, the holes of the fourth row having a radius r₄. The distance between the first row and the second row is denoted d₁, the distance between the second row and the third row is denoted d₂, and the distance between the third row and the fourth row is denoted d₃.

The nanostructures on each side of the guiding region 4 are in general identical. However, position of the holes on one of the sides are shifted half a longitudinal lattice constant (a/2) in the longitudinal direction.

In a conventional type B photonic crystal waveguide, the distance between rows is identical √3/2 times the lattice constant a, whereas the width of the guiding region is √3/2 times the lattice constant a. Further, the radii of the holes are typically the same.

In the present invention, the nanostructures are modified to exhibit dispersion curves as shown in FIG. 2. The planar waveguide 2 is adapted to guide a forward-propagating mode exhibiting an in-plane counter clockwise polarisation, and where the energy band is monotonically increasing as a function of the wave vector, and adapted to guide a backward-propagating mode exhibiting an in-plane clockwise polarisation, and where the energy band is monotonically decreasing as a function of the wave vector. The two energy bands intersect at the Brillouin zone edge (depicted with a dashed line) with equal but opposite group velocities forming a Dirac point. The two modes are locally non-degenerate. Orthogonality requires that these two modes are locally orthogonal, but the symmetry requires that they are degenerate at the Brillouin zone edge. The only way this can happen is if the two modes have different circular polarizations, which implies that if the forward propagating mode is right-hand circularly polarized at a given position, then the backward propagating mode is left-hand circularly polarized. This in turn means that unavoidable isotropic dielectric perturbations introduced during fabrication cannot couple the forward and backward propagating modes, if the local polarization is circular. Accordingly, backscattering losses may be reduced significantly or avoided all together.

This makes the slow-light generating optical device 1 particular suitable for e.g. optical delay circuits, optical buffers for communication devices, or quantum simulators comprising delay lines.

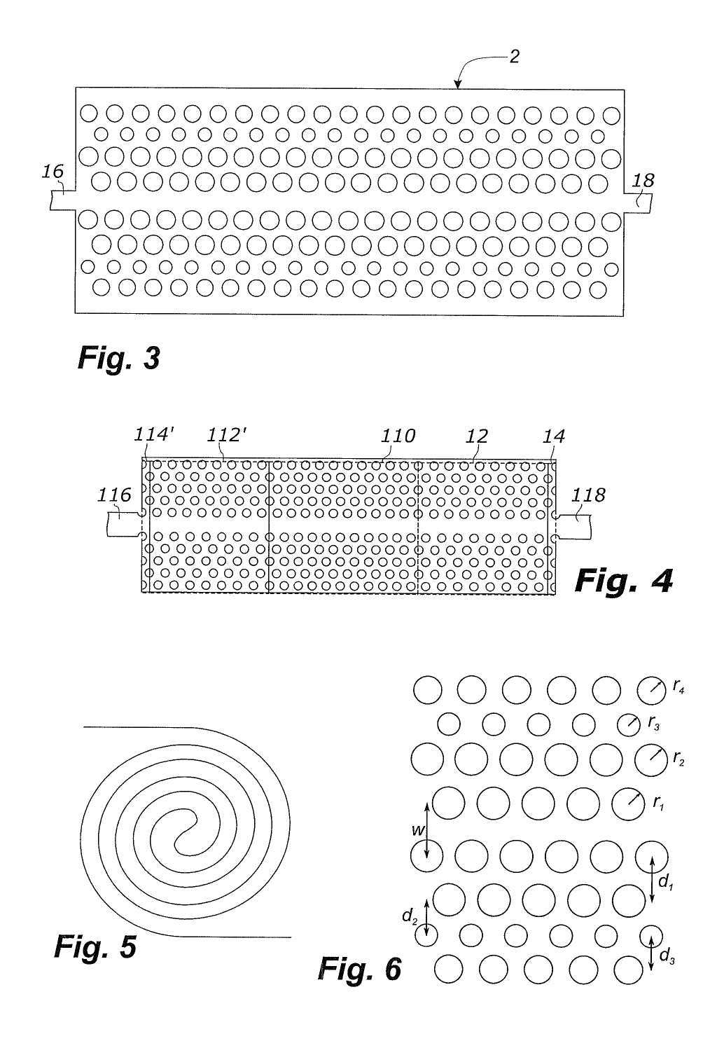

The slow-light generating optical device 1 or the planar waveguide 2 may as shown in FIG. 3 simply be arranged in a larger optical device between an input waveguide 16 and an output waveguide 18, the input waveguide and the output waveguide for instance being ridge waveguides.

It is also possible to design the slow-light generating optical device such that an efficient read-out to standard waveguide technology may be achieved. Such an embodiment is shown in FIG. 4. The planar waveguide comprises a slow-mode section 110 comprising a modified glide-plane symmetric nanostructure having a dispersion characteristic according to the invention. The planar waveguide further comprises an input longitudinal region 114′, and an output longitudinal region 114, in which the first nanostructure and second nanostructure are arranged substantially mirror symmetric (or up-down symmetric) about the guiding region. An input waveguide 116 is directly coupled to the input longitudinal region 114′, and an output waveguide is directly coupled to the output longitudinal region 114 of the planar waveguide.

A first transition region 112′ is arranged between input longitudinal region 114′ and the slow-mode section 10, and a second transition region 112 is arranged between the slow-mode section 10 and the output longitudinal region 114. In the transition regions 112, 112′, the first nanostructure and second nanostructure 9 gradually changes from glide-plane symmetry to mirror symmetry. Thereby, the guided mode is gradually changed from a circular polarisation to a linear polarisation with low or no loss. The light can thereby more efficiently be converted and coupled to conventional waveguide technology such as a ridge waveguide.

It should be noted that the term “longitudinal” does not mean that the guiding region is necessarily arranged along a straight line. The guiding region may for instance have a slight curvature. The guiding region may for instance be arranged along a double-spiral as shown in FIG. 5, where the spiral rings have a sufficient large radius of curvature to avoid adiabatic losses. The figure has for the sake of simplification been depicted without the nanostructures of the photonic crystal waveguide.

It is recognised that the glide-plane symmetric photonic crystal waveguides may be designed in a number of ways to exhibit dispersion characteristics according to the invention as for instance shown in FIG. 2. In the following a number of examples are given, which exhibits such properties.

### Example I

In the first example, shown in FIG. 6, the planar waveguide is designed with circular holes. The radii of the holes in the first to fourth rows are r₁=0.35a, r₂=0.35a, r₃=0.24a, and r₄=0.30a, respectively. The width of the guiding region is w=(0.75√3) a. The distances between adjacent rows are d₁=(1.25√3/2) a, d₂=(0.95√3/2) a, and d₃=(0.90√3/2) a, respectively. The planar waveguide is designed as a membrane having a thickness of 2a/3. The waveguide exhibits a dispersion curve as shown in FIG. 2.

The shown planar waveguide is adapted to guide light with a group index, n_{g}, of 39 at the Dirac point. The experiments showed no Anderson localization occurs over a propagation distance of at least 300 micrometres.

### Example II

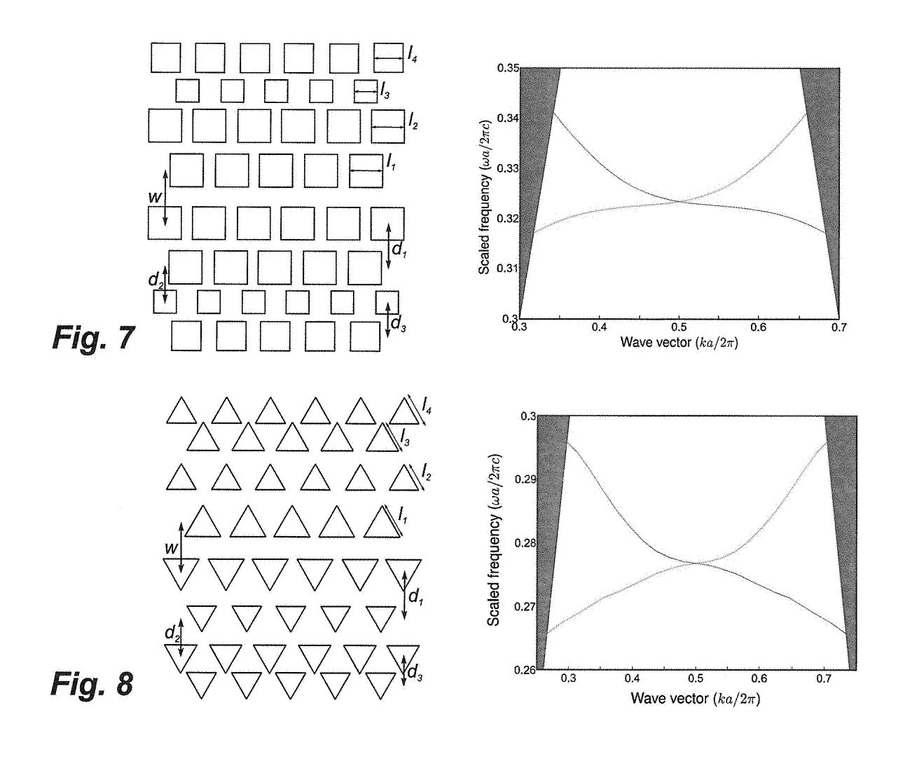

In the second example, shown in FIG. 7, the planar waveguide is designed with square holes. The sides of the holes in the first to fourth rows have a side length of l₁=0.62a, l₂=0.62a, l₃=0.43a, and l₁=0.53a, respectively. The width of the guiding region is w=(0.75√3) a. The distances between adjacent rows are d₁=(1.25√3/2) a, d₂=(0.95√3/2) a, and d₃=(0.90√3/2) a, respectively. The planar waveguide is designed as a membrane having a thickness of 2a/3. The planar waveguide exhibits a dispersion curve as shown to the right in FIG. 7, where the energy bands of forward propagating mode and the backward propagating are substantially mirror symmetric about the Dirac point.

The shown planar waveguide is adapted to guide light with a group index, n_{g}, of 42 at the Dirac point.

### Example III

In the third example, shown in FIG. 8, the planar waveguide is designed with holes formed as equilateral triangles with one side facing towards the guiding region and an apex pointing away from the guiding region. The sides of the holes in the first to fourth rows have a side length of l₁=0.9a, l₂=0.74a, l₃=0.81a, and l₁=0.75a, respectively. The width of the guiding region is w=(0.91√3) a. The distances between adjacent rows are d₁=(1.2√3/2) a, d₂=(1.1√3/2) a, and d₃=(0.78√3/2) a, respectively. The planar waveguide is designed as a membrane having a thickness of 2a/3. The planar waveguide exhibits a dispersion curve as shown to the right in FIG. 8, where the energy bands of forward propagating mode and the backward propagating are substantially mirror symmetric about the Dirac point.

The shown planar waveguide is adapted to guide light with a group index, n_{g}, of 50 at the Dirac point.

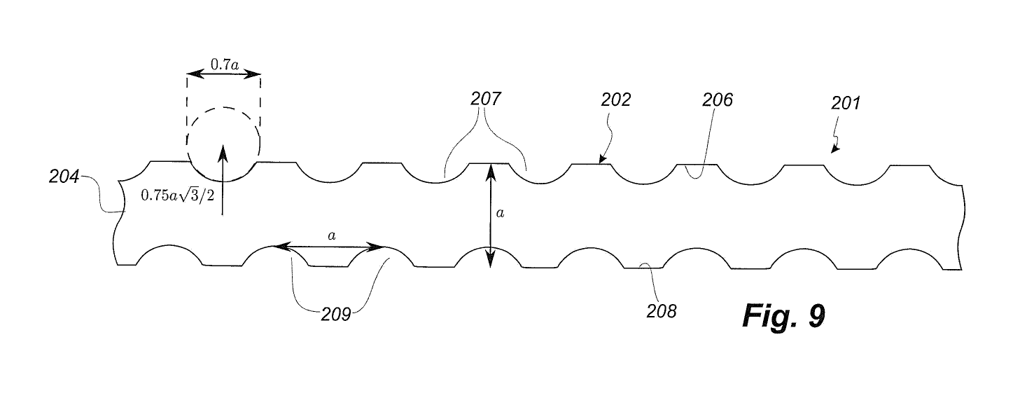

While the invention in the previous embodiments has been described for designs with holes arranged in a triangular lattice structure and particular hole shapes, it is also contemplated that other lattice structures and hole shapes may be utilised. Further, the invention also contemplates that the first and the second nanostructure may comprise indentations, corrugations, undulations or the like formed in the sides of the waveguide. It is contemplated that the first and the second nanostructure may be formed by such indentations, corrugations, undulations or the like only as shown in FIG. 9, or that they may be combined with a hole design similar to the previously described embodiments.

Specifically FIG. 9 illustrates an alternative design for a planar waveguide 202 providing similar energy bands to those in the previous embodiments. In contrast to the previous embodiment, the first and the second nanostructure are not provided as a hole-structure. Instead the nanostructures are formed as indentations, corrugations or undulations in the guiding region of the waveguide, e.g. edged into the sides of the waveguide, such that the waveguide 202 has a sort of wavy design. The planar waveguide 202 comprises a longitudinal extending guiding region 204 with a first side 206 and a second side 208. A first nanostructure 207 comprising indentations edged into the first side 206 of the waveguide 202 is formed on the first side 206 of the guiding region 204. Similarly, a second nanostructure 209 comprising indentations edged into the second side 208 of the waveguide 202 is formed on the second side 208 of the guiding region 204. In at least a first longitudinal section of the waveguide, the first nanostructure 207 and the second nanostructure 209 are arranged substantially glide-plane-symmetric about the guiding region 204 of the planar waveguide 202 by the indentations being mutually shifted in a longitudinal direction of the waveguide 202.

Similar to the afore-mentioned embodiments, the nanostructured waveguide 202 exhibits a band structure corresponding to those shown in FIGS. 2, 7, and 8 and which ensures low backscattering losses from manufacturing imperfections.

In the shown example, the waveguide 202 is composed of a nanobeam with width given by a and with a membrane thickness of t=0.6a. Here, a is the lattice vector, which defines the period of the holes or indentations that are etched into the sides 206, 208 of the nanobeam waveguide 202 giving it a glide-plane symmetry. The holes are centered outside the nanobeam with a distance of 0.75a*sqrt(3)/2 from the centre of the nanobeam. The holes have a diameter of 0.7a.

While the indentations in FIG. 9 are shown as partly circular design, it is also contemplated that the indentations may take other forms.

Thus, it is understood that the important features of the invention are that the waveguide is provided with glide-plane symmetry, facilitates slow-light and provides non-degeneracy in order to ensure low loss. It is clear that conventional type B waveguides do not possess these characteristics and that the glide-plane symmetry is modified compared to the conventional waveguides. As described previously, the waveguide may have various hole designs and shapes, and/or indentations, corrugations, undulations or the like formed in the sides of the waveguide. The holes themselves could also be provided with a wavy design or the like, e.g. forming sines and cosines having mutual glide-plane symmetry.

The invention has been described with reference to advantageous embodiments. However, the scope of the invention is not limited to the illustrated embodiments, and alterations and modifications can be carried out without deviating from the scope of the invention, which is defined by the following claims. For instance, the three examples are given for embodiments, where the waveguide is designed as a membrane. However, according to the invention, is it also possible to utilise a ridge-platform design, such as a silicon-on-insulator wafer, where the waveguide is arranged on a material with a relatively low refractive index.

### LIST OF REFERENCE NUMERALS

| | |
|---|---|
| 1, 201 | Optical device |
| 2, 202 | Planar waveguide |
| 4, 204 | Guiding region |
| 6, 206 | First side |
| 7, 207 | First nanostructure |
| 8, 208 | Second side |
| 9, 209 | Second nanostructure |
| 110 | Slow-mode section |
| 112, 112′ | Transition region |
| 114, 114′ | Output/input longitudinal region |
| 16, 116 | Ridge input waveguide |
| 18, 118 | Ridge output waveguide |
| a | Longitudinal lattice constant |
| d₁, d₂, d₃ | Distance between rows |
| l₁, l₂, l₃, l₄, | Side length of holes |
| r₁, r₂, r₃, r₄, | Radii of holes |
| w | Width of guiding region |

1. A slow-light generating optical device (1), wherein the optical device comprises a planar waveguide (2), wherein the planar waveguide comprises:
a longitudinal extending guiding region (4) with a first side (6) and a second side (8),
a first nanostructure (7) arranged on the first side (6) of the guiding region (4), and
a second nanostructure (9) arranged on the second side (7) of the guiding region (4), wherein
the planar waveguide (2) includes a first longitudinal region where the first nanostructure (7) and the second structure (9) are arranged substantially glide-plane symmetric about the guiding region (4) of the planar waveguide, and wherein
the first and the second nanostructures (7, 9) are designed so that the planar waveguide has a band structure and is configured to guide a forward propagating mode and a backward propagating mode possessing energy bands, wherein
the energy band of the forward propagating mode is monotonically increasing as a function of a wave vector within a finite range on both sides of the first Brillouin zone edge and the backward propagating mode is monotonically decreasing as a function of a wave vector within a finite range on both sides of the first Brillouin zone edge, or vice versa.

2. A slow-light generating optical device according to claim 1, wherein the energy bands of the forward propagating mode and backward propagating mode individually are non-degenerate and mutually degenerate.

3. A slow-light generating optical device according to claim 1, wherein the energy bands of the forward propagating mode and the backward propagating mode cross each other at a crossing-point.

4. A slow-light generating optical device according to claim 3, wherein the energy bands of the forward propagating mode and the backward propagating mode are substantially symmetric about the crossing point.

5. A slow-light generating optical device according to claim 3, wherein the energy bands of the forward propagating mode and the backward propagating mode form a Dirac point.

6. A slow-light generating optical device according to claim 5, wherein the Dirac point is formed at a Brillouin zone edge.

7. A slow generating optical device according to claim 6, wherein the Brillouin zone edge is formed at k*a/(2*pi)=0.5, where k is the wavenumber, and a is a lattice constant of the first and second nanostructure.

8. A slow-light generating optical device according to claim 1, wherein the forward propagating mode and the backward propagating mode are counter-propagating circular polarized modes.

9. (canceled)

10. A slow-light generating optical device according to claim 1, wherein the planar waveguide is a photonic-crystal waveguide.

11. A slow-light generating optical device according to claim 1, wherein the planar waveguide is designed so that a group velocity of a guided forward propagating mode is significantly lower than c/n, where c is the velocity of light and n is the refractive index of the waveguide material.

12. A slow-light generating optical device according to claim 11, wherein a group velocity of the guided forward propagating mode is at least a factor 5 lower than the speed of light in vacuum, e.g. at least a factor 10, or 15, or 20, or 25 lower than the speed of light in vacuum.

13. A slow-light generating optical device according to claim 1, wherein the planar waveguide is made from a dielectric material, such as an III-V semiconductor material or a silicon-based material, e.g. silicon dioxide and/or silicon nitride.

14. A slow-light generating optical device according to claim 1, wherein the first nanostructure (7) and the second nanostructure (9) are arranged in a first lattice structure and a second lattice structure, respectively, having a longitudinal lattice constant a.

15. A slow-light generating optical device according to claim 1, wherein the planar waveguide has a longitudinal extent of at least 50 micrometres, advantageously at least 100 micrometres.

16. A slow-light generating optical device according to claim 14, wherein the lattice constant a lies in the interval 100-500 nm, or 150-400 nm, or 200-300 nm, e.g. around 250 nm.

17. A slow-light generating optical device according to claim 14, wherein the planar waveguide has a thickness of between 0.2a and 1.4a, or between 0.25a and 1.0a, or between 0.3a and 0.8a, e.g. around 0.5a or 0.6a.

18. A slow-light generating optical device according to claim 1, wherein the first nanostructure and/or the second nanostructure comprise a number of first rows comprising first holes proximal to the guiding region, and a number of second rows comprising second holes juxtaposed to the first rows, wherein the first holes have a first diameter or first maximum inner dimension, and the second holes have a second diameter or second maximum inner dimension, being different from the first diameter.

19. A slow-light generating optical device according to claim 18, wherein the second diameter or second maximum inner dimension is smaller than the first diameter or first maximum inner dimension, e.g. 50-90% of the first diameter or first maximum inner dimension.

20. A slow-light generating optical device according to claim 18, wherein the first nanostructure and/or the second nanostructure additionally comprise a number of third rows comprising third holes juxtaposed to the second rows, wherein the third holes have a third diameter or third maximum inner dimension, and wherein the third diameter or third maximum inner dimension is different from the second diameter or second maximum inner dimension, e.g. wherein the second diameter or second maximum inner dimension is smaller than the third diameter or third maximum inner dimension, such as 50-90% of the third diameter or third maximum inner dimension.
mode and the backward propagating mode at a given wavelength of light.

21. A slow-light generating optical device according to claim 1, wherein the first and/or the second nanostructure comprise indentations, corrugations, undulations or the like formed in lateral sides of the waveguide.

22. A slow-light generating optical device according to claim 1, wherein the first and the second nanostructures are designed so that the waveguide is configured to only guide the forward propagating mode and the backward propagating mode.

23. A method of producing slow light, wherein the method comprises the step of guiding light into a planar waveguide comprising a longitudinal extending guiding region with a first side and a second side, a first nanostructure arranged on the first side of the guiding region, and a second nanostructure arranged on the second side of the guiding region, where the first nanostructure and the second structure are arranged substantially glide-plane symmetric about the guiding region of the planar waveguide, characterised in that the first and the second are designed so that the planar waveguide has a band structure and is configured to guide a forward propagating mode and a backward propagating mode possessing energy bands, wherein the energy band of the forward propagating mode is monotonically increasing as a function of a wave vector within a finite range on both sides of the first Brillouin zone edge and the backward propagating mode is monotonically decreasing as a function of a wave vector within a finite range on both sides of the first Brillouin zone edge, or vice versa.

24. A slow-light generating optical device (1), wherein the optical device comprises a planar waveguide (2), wherein the planar waveguide comprises:
a longitudinal extending guiding region (4) with a first side (6) and a second side (8),
a first nanostructure (7) arranged on the first side (6) of the guiding region (4), and
a second nanostructure (9) arranged on the second side (7) of the guiding region (4), wherein
the planar waveguide (2) includes a first longitudinal region where the first nanostructure (7) and the second structure (9) are arranged substantially glide-plane symmetric about the guiding region (4) of the planar waveguide, and wherein
the first and the second nanostructures (7, 9) are designed so that the planar waveguide has a band structure and is adapted to guide a forward propagating mode and a backward propagating mode possessing energy bands, which individually are non-degenerate and mutually degenerate, and which intersect each other and form a Dirac point at a Brillouin zone edge.

25. A method of producing slow light, wherein the method comprises the step of guiding light into a planar waveguide comprising a longitudinal extending guiding region with a first side and a second side, a first nanostructure arranged on the first side of the guiding region, and a second nanostructure arranged on the second side of the guiding region, where the first nanostructure and the second structure are arranged substantially glide-plane symmetric about the guiding region of the planar waveguide, characterised in that the first nanostructures are designed so that the planar waveguide is adapted to guide a forward propagating mode and a backward propagating mode possessing band structures, which individually are non-degenerate and mutually degenerate, and which intersect each other and form a Dirac point at a Brillouin zone edge.
